(19) United States
(12) Patent Application Publication
(10) Pub. No.: US 2010/0278376 A1
(43) Pub. Date: Nov. 4, 2010

(54) SYSTEM FOR COUNTING A NUMBER OF MOVING OBJECTS

(75) Inventors: Chia-Chun Tsou, Taipei County (TW); Chih-Heng Fang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UTECHZONE CO., LTD., Taipei County (TW)

(21) Appl. No.: 12/623,754

(22) Filed: Nov. 23, 2009

(30) Foreign Application Priority Data
Apr. 29, 2009 (TW) 98114289

(51) Int. Cl. G06K 9/00; H04N 5/225

(52) U.S. Cl. 382/100; 348/169; 348/E05.022

(57) ABSTRACT

A system and methodology that counts a number of moving objects including the pedestrians within predetermined areas. According to certain embodiments, a system comprises an image sensing device and a data processing device. The image sensing device is situated at a predetermined area. The image sensing device retrieves a series of images of the moving objects within the predetermined area. The data processing device is coupled to the image sensing device. The data processing device processes the retrieved image to generate a dynamic background of the first predetermined area and determine a flow of the moving objects thereon.

### BACKGROUND OF THE INVENTION

1. Field of the Invention

The present invention relates generally to a system for counting a number of moving objects, and more particularly to a system for detecting number of people, speed of pedestrians and the direction thereof.

2. Description of Prior Art

Conventional inductive loop vehicle detectors provide information about vehicles in an area of the roadway. The inductive loop detector is low cost and well known technology, but it typically can only monitor a small area. In practice, a loop is embedded in a lane of a roadway, and the loop magnetically senses when a large mass of metal passes over it. By placing two loops a known distance apart, the speed of a vehicle across the two loops can be measured with limited accuracy. Loops therefore provide vehicle count and speed at a specific point in each lane to the traffic manager. Multiple traffic lanes require multiple sets of loops (typically one loop per traffic lane).

Current techniques available in the conventional inductive loop detector provide no notion of how to solve the problem of detecting a number of pedestrians, not to mention the result of detecting a speed of pedestrians and their corresponding direction of movement.

### SUMMARY OF THE INVENTION

Embodiments of the present invention provide a counting system and method to resolve the foregoing problems faced by the conventional inductive loop detector. Embodiments of the present invention also enjoy the advantage of providing information concerning speed of pedestrians and their relative direction of movement.

An object of the present invention is to provide a counting system and method, wherein detailed information on number, speed and direction of moving objects is detected and stored.

In accordance with an aspect of the present invention, a counting system comprises an image sensing device and a data processing device. The image sensing device is situated at the predetermined area. The image sensing device retrieves a series of images of the moving objects within the predetermined area. The data processing device is coupled to the image sensing device. The data processing device processes the retrieved image to generate a dynamic background of the first predetermined area and determine flow of the moving objects thereon.

In embodiments of the invention, the image sensing device may be waterproof, wireless, and may comprise a CCD (Charge Coupled Device) camera. In embodiments of the invention, the image sensing device is situated at the first predetermined location. In certain embodiments, the first predetermined location is an intersection. The data processing device is situated at the first predetermined location. The data processing device is situated at a second predetermined location. The system further comprises a storing device. The storing device is used for storing data to be processed by the data processing device. In certain embodiments, the storing device is used for storing data processed by the data processing device, and the storing device is situated at the first predetermined location. In other embodiments, the storing device is situated at the second predetermined location, and the data processing device is situated at the second predetermined location as well. In yet other embodiments, the storing device is situated at a third predetermined location, while the data processing device is situated at the second predetermined location.

In accordance with another aspect of the present invention, a counting system comprises: an image collecting unit situated at a first predetermined location for collecting image of the first predetermined location; a storing unit for storing image collected by the image collecting unit; and a determining unit for determining pedestrian flow in the first predetermined location, wherein the determining unit has a generating module for generating a background of the first predetermined location, and a discriminating module for discriminating the pedestrian flow in the first predetermined location.

In one embodiment of the invention, the first predetermined location is an intersection. The determining unit is situated at the first predetermined location. The determining unit is situated at a second predetermined location. In various embodiments, the storing unit may be situated at the first predetermined location, the second predetermined location, or a third predetermined location.

The present invention may best be understood through the following description with reference to the accompanying drawings, in which:

### BRIEF DESCRIPTION OF THE DRAWINGS

FIG. 1 shows a schematic block diagram of a counting system of an embodiment according to the present invention.

FIG. 2 shows a schematic flow chart of a counting system of another embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

Embodiments of the present invention embody a new counting system to detect a number, speed, and direction of moving objects. Accordingly, the information can be stored and add value in analyzing pedestrian flow at a predetermined location or area.

According to one embodiment of the present invention, a counting system comprises an image sensing device and a data processing device. The image sensing device is situated at a predetermined area. The image sensing device retrieves a series of images of the moving objects within the predetermined area. The data processing device is coupled to the image sensing device. The data processing device processes the retrieved image to generate a dynamic background of the first predetermined area and determine flow of the moving objects thereon.

In certain embodiments, the image sensing device may be waterproof, wireless, and may comprise a CCD (Charge Coupled Device) camera. Such embodiments are well suited for being situated outdoors, and for the ready communication of information, without requiring hard-wiring of the device components. The image sensing device is situated at the first predetermined location. In one embodiment, the first predetermined location is at least an intersection and the image sensing device is configured to count pedestrians.

In one embodiment, the data processing device is situated at the first predetermined location, while in other embodiments, the data processing device is situated at a second predetermined location. The system further comprises a storing device. In varying embodiments, the storing device may be situated at any of a first, second, or third predetermined location. The data processing device may be store at the same location as the storing device or at a different location. The storing device is used for storing data to be processed by the data processing device. The storing device is used for storing data processed by the data processing device. The storing device is situated at the first predetermined location. The storing device is situated at the second predetermined location, and the data processing device is situated at the second predetermined location. the storing device is situated at a third predetermined location, and the data processing device is situated at the second predetermined location.

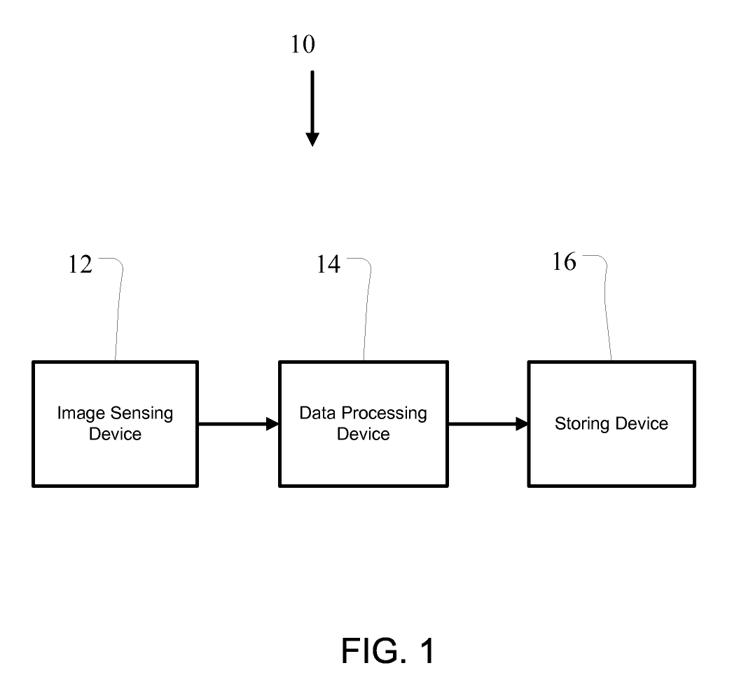

Referring to FIG. 1, a schematic block diagram of a counting system of a preferred embodiment according to a preferred embodiment of the present invention is shown. The counting system 10 of the illustrated embodiment is adapted for counting the number of moving objects, which comprises an image sensing device 12 and a data processing device 14.

The image sensing device 12 is situated at the predetermined area. The image sensing device 12 retrieves a series of images of the moving objects within the predetermined area. The image sensing device 12 may be waterproof. The image sensing device may be wireless. The image sensing device may be at least a CCD (Charge Coupled Device) camera. The image sensing device is situated at the first predetermined location, and the first predetermined location may be at least an intersection.

The data processing device 14 is coupled to the image sensing device. The data processing device 14 processes the retrieved image to generate a dynamic background of the first predetermined area and determine flow of the moving objects thereon. The data processing device 14 may be situated at the first predetermined location. Alternatively, the data processing device 14 may be situated at a second predetermined location.

The system further comprises a storing device 16. The storing device 16 may be used for storing data to be processed by the data processing device. Alternatively, the storing device 16 may be used for storing data processed by the data processing device. The storing device 16 may be situated at the first predetermined location. Alternatively, the storing device may be situated at the second predetermined location, and the data processing device is situated at the second predetermined location. Otherwise, the storing device may be situated at a third predetermined location, and the data processing device is situated at the second predetermined location.

For the sake of cost and efficiency, one may just equip the image sensing device 12 on the intersection, while the retrieved image is remotely transmitted to the data processing device 14 and the storing device 16 for further added value processing.

According to another embodiment of the present invention, a system comprises: an image collecting unit situated at a first predetermined location for collecting image of the first predetermined location; a storing unit for storing image collected by the image collecting unit; and a determining unit for determining pedestrian flow in the first predetermined location, wherein the determining unit has a generating module for generating a background of the first predetermined location, and a discriminating module for discriminating the pedestrian flow in the first predetermined location.

In one embodiment, the first predetermined location is an intersection, and the determining unit is situated at the first predetermined location. In another embodiment, the determining unit is situated at a second predetermined location. Similarly, in various embodiments, the storing unit may be situated at either the first predetermined location, the second predetermined location, or the third predetermined location.

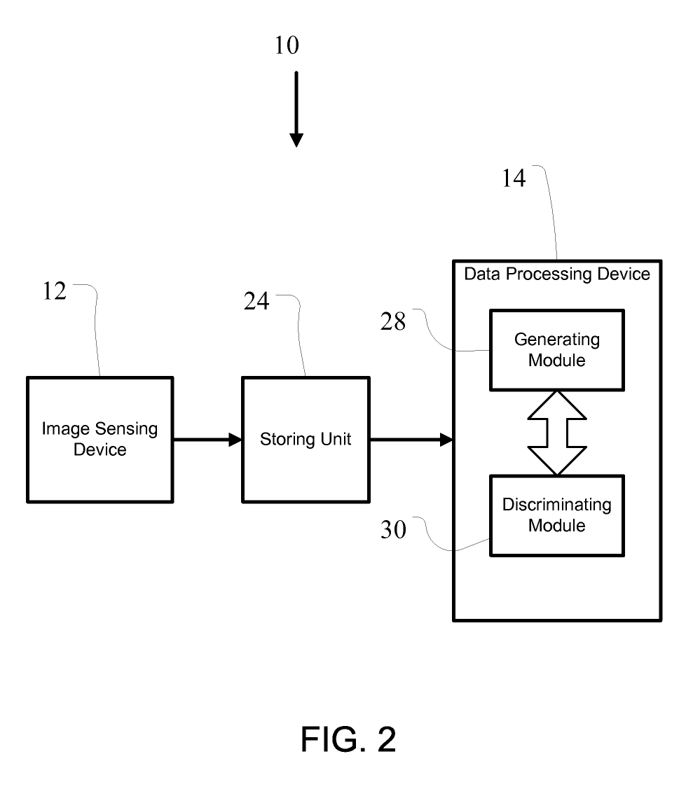

Referring to FIG. 2, a schematic block diagram of a counting system of another embodiment, according to the present invention, is shown. The counting system 10 of this embodiment is adapted for counting the number of moving objects, which comprises an image collecting unit 22, a storing unit 24 and a determining unit 26.

The image collecting unit 22 is situated at a first predetermined location for collecting image of the first predetermined location. The first predetermined location is at least an intersection. The image collecting unit 22 may be waterproof. The image collecting unit 22 may be wireless. The image collecting unit 22 may be at least a CCD (Charge Coupled Device) camera.

The storing unit 24 is coupled to the image collecting unit 22. The storing unit 24 is used for storing image collected by the image collecting unit 22. The determining unit 26 is used for determining pedestrian flow in the first predetermined location, wherein the determining unit 26 has a generating module 28 and a discriminating module 30. The generating module 28 is used for generating a background of the first predetermined location. The discriminating module 30 is used for discriminating the pedestrian flow in the first predetermined location.

The determining unit 26 may be situated at the first predetermined location. Alternatively, the determining unit 26 may be situated at a second predetermined location. The storing unit 24 may be situated at the first predetermined location. Alternatively, the storing unit 24 may be situated at the second predetermined location, along with the determining unit 26. Also, the storing unit may be situated at a third predetermined location separately.

For the sake of cost-savings and efficiency, one may just equip the image collecting unit 22 at the intersection, while the retrieved image is remotely transmitted to the storing unit 24 and the determining unit for further added value processing.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A system for counting a number of moving objects comprising:
an image sensing device situated at a first predetermined location for sensing an image; and
a data processing device coupled to said image sensing device for processing said image to generate a background of said first predetermined location and determine flow of moving objects thereon.

2. The system according to claim 1, wherein said image sensing device is waterproof.

3. The system according to claim 1, wherein said image sensing device is wireless.

4. The system according to claim 1, wherein said image sensing device is a CCD (Charge Coupled Device) camera.

5. The system according to claim 4, wherein said image sensing device is situated at said first predetermined location, and said first predetermined location is at least an intersection.

6. The system according to claim 5, wherein said data processing device is situated at said first predetermined location.

7. The system according to claim 5, wherein said data processing device is situated at a second predetermined location.

8. The system according to claim 5, further comprising a storing device.

9. The system according to claim 8, wherein said storing device is configured to store data to be processed by said data processing device.

10. The system according to claim 8, wherein said storing device is configured to store data processed by said data processing device.

11. The system according to claim 8, wherein said storing device is situated at said first predetermined location.

12. The system according to claim 8, wherein said storing device is situated at said second predetermined location, and said data processing device is situated at said second predetermined location.

13. The system according to claim 8, wherein said storing device is situated at a third predetermined location, and said data processing device is situated at said second predetermined location.

14. A system for counting a number of pedestrians comprising:
an image collecting unit situated at a first predetermined location for collecting an image of said first predetermined location;
a storing unit for storing image collected by said image collecting unit; and
a determining unit for determining pedestrian flow in said first predetermined location, wherein said determining unit has a generating module for generating a background of said first predetermined location, and a discriminating module for discriminating said pedestrian flow in said first predetermined location.

15. The system according to claim 14, wherein said first predetermined location is an intersection.

16. The system according to claim 14, wherein said determining unit is situated at said first predetermined location.

17. The system according to claim 14, wherein said determining unit is situated at a second predetermined location.

18. The system according to claim 14, wherein said storing unit is situated at said first predetermined location.

19. The system according to claim 14, wherein said storing unit is situated at said second predetermined location.

20. The system according to claim 14, wherein said storing unit is situated at a third predetermined location.
